(19) United States
(12) Patent Application Publication
(10) Pub. No.: US 2014/0164708 A1
(43) Pub. Date: Jun. 12, 2014

(54) SPILL DATA MANAGEMENT

(71) Applicant: ADVANCED MICRO DEVICES, INC., Sunnyvale, CA (US)

(72) Inventors: Mauricio Breternitz, JR., Austin, TX (US); James M. O'Connor, Austin, TX (US); Srilatha Manne, Portland, OR (US); Yasuko Eckert, Kirkland, WA (US)

(73) Assignee: Advanced Micro Devices, Inc., Sunnyvale, CA (US)

(21) Appl. No.: 13/708,090

(22) Filed: Dec. 7, 2012

(51) Int. Cl. G06F 12/08; G06F 12/12

(52) U.S. Cl. CPC G06F 12/0875; G06F 12/122; G06F 12/0855
USPC 711/132; 711/140; 711/136

(57) ABSTRACT

A processor discards spill data from a memory hierarchy in response to the final access to the spill data has been performed by a compiled program executing at the processor. In some embodiments, the final access determined based on a special-purpose load instruction configured for this purpose. In some embodiments the determination is made based on the location of a stack pointer indicating that a method of the executing program has returned, so that data of the returned method that remains in the stack frame is no longer to be accessed. Because the spill data is discarded after the final access, it is not transferred through the memory hierarchy.

### FIELD OF THE DISCLOSURE

The present disclosure relates generally to data management at a processor and more particularly to management of spill data at processor.

### BACKGROUND

A compiler typically compiles source code such that the resulting compiled program maintains frequently accessed data values at an executing processor's registers, where the data can be accessed quickly. In some scenarios the processor does not have a sufficient number of available registers to store all data that is to be accessed by the compiled program. Accordingly, the compiler inserts designated code (“spill code”) to “spill” less frequently accessed data (the “spill data”) to a memory hierarchy associated with the processor. The spill data is stored at the memory hierarchy until it is needed by the executing program, whereupon it is retrieved from the memory hierarchy and transferred to the processor's registers. Spill data can persist in the memory hierarchy long after it is no longer needed, thereby consuming memory bandwidth, power, and other processor resources.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a processing system in accordance with some embodiments.

FIG. 2 is a block diagram illustrating a stack of the processing system of FIG. 1 in accordance with some embodiments.

FIG. 3 is a block diagram illustrating compilation of source code to generate a load instruction to discard data from a memory hierarchy in accordance with some embodiments.

FIG. 4 is flow diagram of a method of discarding spill data stored at a cache in accordance with some embodiments.

FIG. 5 is flow diagram of a method of discarding spill data from a stack in accordance with some embodiments.

FIG. 6 is a flow diagram illustrating a method for designing and fabricating an integrated circuit device implementing at least a portion of a component of a processing system in accordance with some embodiments.

The use of the same reference symbols in different drawings indicates similar or identical items.

### DETAILED DESCRIPTION

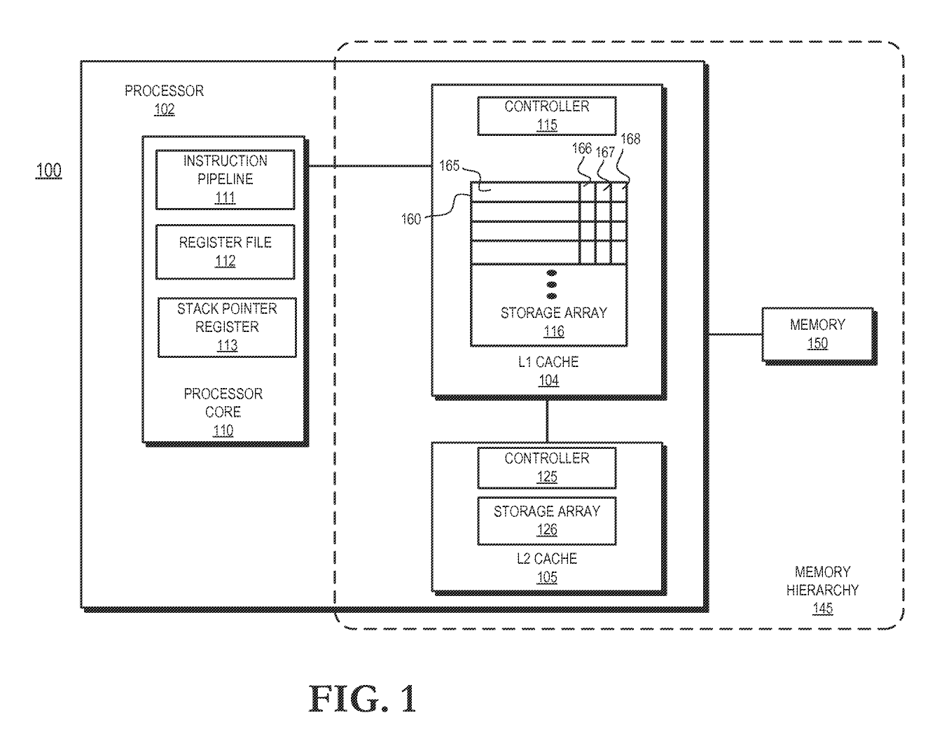

FIGS. 1-6 illustrate example techniques for reducing the impact of spill data on processor efficiency and power consumption. A processor discards spill data from a memory hierarchy in response to the final access to the spill data having been performed by a compiled program executing at the processor. In some embodiments, the final access is determined as such based on a special-purpose load instruction configured for this purpose. In some embodiments the determination is made based on the location of a stack pointer indicating that a method of the executing program has returned, so that data of the returned method that remains in the stack frame is no longer to be accessed. Because the spill data is discarded after the final access, it is not transferred through the memory hierarchy, thus reducing power consumption and improving processor efficiency.

To illustrate using an example, a processor has five registers it uses to manipulate data, while a segment of software (code) to be executed by the processor manipulates six variables. Accordingly, a compiler compiles the code by first determining which four of the variables are most frequently manipulated by the code. For those four variables, the compiler compiles the code so that the variable values are maintained at four corresponding registers of the processor. For the remaining two variables (the spill data), the compiler creates spill code that 1) allocates an addressable memory location in a memory hierarchy of the processor for each of the two variables; and 2) loads and stores each variable to and from the fifth register of the processor (the register that does not store one of the four most frequently manipulated variables) so that the variables are manipulated according to the code instructions. For example, if VARX is one of the spill data variables, and the uncompiled code requires the addition of a constant value A to VARX, the compiler can automatically create spill code to 1) load VARX from the memory hierarchy of the processor to the fifth register; 2) add the constant value A to the value stored at the fifth register; and 3) store the resulting value at the fifth register to the VARX memory location in the memory hierarchy. The spill code thus allows for the manipulation of variables when all of the variables cannot fit within the processor registers.

However, maintenance of the spill data in the memory hierarchy consumes processor resources. In particular, the processor maintains the integrity of the memory hierarchy by transferring data through different levels of the hierarchy, as described further herein. Each of these transfers consumes power and other processor resources. Further, in conventional processors spill data is maintained in the memory hierarchy even after it is no longer used by an executing program. Accordingly, the compiler and processor described herein can determine the final access to a particular data by an executing program, and can discard that data from the memory hierarchy. Because the data is discarded, it is no longer transferred by the processor to different levels of the memory hierarchy, thereby conserving power.

To illustrate using the example above, the compiler can analyze the uncompiled code and determine that the addition of the constant value A to the variable VARX is the last time that the VARX value is manipulated by the executing program. Accordingly, instead of using a normal load instruction to transfer VARX from the memory hierarchy to the register, the compiler inserts a special-purpose load instruction that discards VARX from the memory hierarchy (e.g. by invalidating a cache line associated with VARX). The compiler also omits storing VARX to the memory hierarchy. VARX has thus been discarded from the memory hierarchy, saving processor resources.

As used herein, discarding data refers to setting the data, or control information associated therewith, so that the data is not transferred from the level of the memory hierarchy in which it currently resides to another level of the memory hierarchy. In some embodiments, the data can persist at the level of the memory hierarchy from which it was loaded for some time after it is indicated as discarded, but it is no longer transferred to other levels of the memory hierarchy once it has been so indicated.

FIG. 1 illustrates a processing system 100 configured to manage spill data in accordance with some embodiments. The processing system 100 can be incorporated into any device that employs a processor and memory, such as a personal computer, a tablet computer, a server, a portable electronic device such as a computing-enabled cell phone, an automotive device, a game console, and the like. The processing system 100 includes a processor 102 and a memory 150. The processor 102 is generally configured to execute sets of instructions arranged as computer programs. In some embodiments the computer programs are prepared according to a particular program language, resulting in an uncompiled program (source code). A compiler is executed, either at the processor 102 or at an external compiler (e.g. another processing system) to generate a set of machine-readable instructions (that is, a compiled program) for execution at the processor 102, whereby the machine-readable instructions represent the logic and program flow of the uncompiled program. In the course of compiling the source code, the compiler can perform optimizations such as removal of source code that is not used by the compiled program, transformation of variables into constant values, management of loops, and the like. The compiled program is stored at the memory 150, which can include random access memory (RAM), flash memory, one or more disc drives or solid-state storage devices, and the like, or a combination thereof.

The processor 102 includes a processor core 110 that executes the compiled program. In particular, the processor core 110 implements an instruction pipeline 111 having a plurality of stages, whereby each stage carries out particular operations as part of an instruction's execution. For example, the instruction pipeline 111 can include a fetch stage to fetch instructions in a program order, a decode stage to decode fetched instructions into sets of micro-operations, a dispatch stage to dispatch the micro-operations for execution, an execution stage having a plurality of execution units to execute the dispatched micro-operations, and a retire stage to manage retirement of instructions.

The processor 102 also includes a set of N caches, where N is an integer. In the illustrated example, the processor 102 includes 2 caches: a cache 104, and a cache 105. The caches 104 and 105 store data, including spill data, that is manipulated by the processor 102 during execution of instructions. The processor 102 can also include another set of caches arranged in a hierarchy that stores the instructions to be executed by the processor core 110.

The caches 104 and 105 and the memory 150 together form a memory hierarchy 145 for the processing system 100. The memory 150 is located at the lowest level of the memory hierarchy 145, and the caches 104 and 105 are each located at a different corresponding level of the memory hierarchy 145. Thus in the illustrated example of FIG. 1, the cache 104 is located at the highest level of the memory hierarchy 145, and therefore is referred to as the L1 (“level 1”) cache 104. The cache 105 is located at the next higher level in the memory hierarchy 145, and therefore is referred to as the L2 (“level 2”) cache 105. In some embodiments, each successively higher level of the memory hierarchy 145 is successively smaller (has a smaller capacity to store data). Thus, for example, the L1 cache 104 capacity is smaller than the capacity of the L2 cache 105. The processor 102 typically stores and retrieves data from the memory hierarchy 145 via the L1 cache 104 and does not directly store or retrieve data from other levels of the memory hierarchy 145. Accordingly, data located at lower levels of the memory hierarchy 145 is provided to the processor 102 by having the data traverse each level of the memory hierarchy 145 until it reaches the L1 cache 104.

Each of the caches 104 and 105 includes a controller and a storage array. The storage array for each of the caches 104 and 105 is a set of storage elements, such as bitcells, configured to store data. The controller for each of the caches 104 and 105 is configured to manage the storage and retrieval of data at its corresponding storage array. In the illustrated example, the L1 cache 104 includes the cache controller 115 and the storage array 116 and the L2 cache 105 includes the controller 125 and the storage array 126.

The processor core 110 includes a register file 112 having one or more registers that store data to be manipulated by the instruction pipeline in the course of executing designated compiled instructions. In particular, a compiled program typically includes (load request) to transfer data from the memory hierarchy 145 to the register file 112. The compiled program typically also includes instructions that manipulate the transferred data stored at the register file 112, such as by performing arithmetic operations on the transferred data. The compiled program can also include store requests that transfer the results of the data manipulations from the register file 112 to the memory hierarchy 145. The compiled program is compiled such that frequently accessed data is maintained at a subset of the registers of the register file 112, while spill data is transferred to and from the memory hierarchy 145 as needed by the compiled program via load and store requests.

In response to a load or store request, the instruction pipeline 111 generates a demand request and provides it to the L1 cache 104. The cache controller 115 analyzes the memory address for the demand request and determines if the storage array 116 stores the data associated with the memory address. If so, the cache controller 115 satisfies the demand request by providing the data associated with the memory address to the instruction pipeline 111.

If the cache controller 115 determines that the storage array 116 does not store data associated with the memory address, it indicates a cache miss and provides the demand request to the L2 cache 105. In response to the demand request, the controller 125 analyzes the memory address for the demand request and determines if the storage array 126 stores the data associated with the memory address. If so, the controller 125 provides the data to L1 cache 104 for storage at the storage array 116. The cache controller 115 then satisfies the demand request using the data stored at the storage array 116. If the controller 125 determines that the storage array 126 does not store data associated with the memory address, it indicates a cache miss and provides the demand request to the memory 150. In response, the memory 150 provides the data to the controller 135 for traversal up the memory hierarchy 145 to the L1 cache 104.

In some embodiments, each of the caches 104-106 stores data provided from the cache at the next higher level in response to a demand request. Lower level caches in general have a higher capacity (e.g. more storage cells) than higher level caches and therefore can store more data. In some embodiments, the controllers of the caches 104-106 can implement different policies, whereby a cache may provide data to the next higher level without storing the data at its storage array.

In response to receiving data from the L2 cache 105 responsive to a demand request, the cache controller 115 determines a location of the storage array 126 to store the data. In the illustrated example, the storage array is divided into segments, referred to as cache lines (e.g. cache line 160). Each cache line includes a data portion (e.g. data portion 165 of cache line 160) and a control portion including a valid field (e.g. valid field 166 of cache line 160), a clean field (e.g. clean field 167 of cache line 160), and a least-recently-used (LRU) field (e.g. LRU field 168 of cache line 160). The cache controller 115 uses the control fields of each cache line to select a cache line to store data received responsive to a demand request. To illustrate, the valid field of a cache line indicates whether the data stored at the cache line is valid or invalid, whereby invalid data is eligible for replacement with data received from the L2 cache 105. The cache controller 115 can invalidate a cache line in response to indications of selected events, such as that another processor core or system module has altered the data at the memory address associated with the cache line.

The clean field indicates whether the data stored at the cache line has been modified by the instruction pipeline 111 and the modified data has not been provided to the cache line for storage. Accordingly, the cache controller 115 sets the clean field for a cache line is set to indicate clean (unmodified) data in response to the initial storage at the cache line of particular data received from the L2 cache 105. In response to receiving a load request from the instruction pipeline 111 for the data stored at the cache line the cache controller 115 provides the data to the instruction pipeline 111 and sets the clean field to indicate dirty (modified) data.

The LRU field of a cache line indicates how recently the data at the cache line was the subject of a load or store request at the instruction pipeline 111. In particular, in response to data initially being stored at a cache line, the cache controller 115 sets the LRU field for the cache line to an initial value (e.g. zero). In response to a load or store request for a given cache line, the cache controller 115 sets the LRU field for the cache line to the initial value and increments the values at the LRU fields for all the cache lines that were not targeted by the load or store request. Accordingly, the LRU fields store values that indicate which of the cache lines at the storage is the least recently used cache line.

In response to receiving data from the L2 cache 105, the cache controller 115 determines if any of the cache lines at the storage array 116 stores invalid data. If so, the cache controller 115 selects one of the invalid cache lines and stores the data there. If none of the cache lines stores invalid data the cache controller 115 selects the cache line that has been least recently used, as indicated by the LRU fields of the storage array 116. If the clean field for the selected cache line indicates it is dirty, the cache controller 115 provides the data at the cache line to the L2 cache 105, which in turn provides the data to the memory 150 for storage. The cache controller 115 thus ensures that data stored at the memory 150 is kept up-to-date. After providing the data to the L2 cache 105, or if the clean field indicates the data is clean, the cache controller 115 replaces the data at the selected cache line with the data received from the L2 cache 105.

In some scenarios, spill data at a cache line is no longer needed by an executing program, but may remain in the memory hierarchy until action is taken to remove it. For example, a compiled program may call a process, routine, sub-routine, or other method that generates temporary data to calculate a value to be returned. Once the value is returned by the method, the temporary data is no longer needed by the compiled program. Accordingly, the cache controller 115 is configured to determine when a load access to a cache line is the final access to the data stored at the cache line by an executing program or by a method of an executing program. In response to determining the final access to the data, the cache controller 115 discards the data. In some embodiments, the cache controller 115 discards the data by setting the validity field for the cache line to an invalid state, thus making the cache line eligible for replacement by data received from the L2 cache. In some embodiments, the cache controller 115 discards the data by setting the LRU field for the cache line so that the cache line is indicated as the least recently used cache line. The cache controller 115 also sets the clean field for the cache line to indicate clean data, thus preventing the data at the cache line from being transferred to the L2 cache or elsewhere in the memory hierarchy 145 when the cache line is replaced.

In some embodiments, the cache controller 115 determines the final access to data stored at a cache line in response to a special-purpose load instruction that explicitly indicates that the corresponding access is the final access. To illustrate, during compilation of source code, a compiler can identify the final access to a variable included in a called method. In some embodiments, the method source code is associated with a program order that indicates the order in which instructions are to be executed to achieve the task associated with the method. The compiler analyzes the program order, as indicated by the order of instructions in the method source code, and determines which of the instructions is the final access to the variable. In response, the compiler automatically generates the special-purpose load instruction to load the data associated with the variable and places the special-purpose load instruction in the compiled program. During execution of the compiled program, the instruction pipeline 111 indicates the special-purpose load instruction to the cache controller 115. In response, the cache controller 115 provides the data from the cache line indicated by the special-purpose load instruction and then discards the data from the cache line. In some embodiments, the special-purpose load instruction is indicated by a designated op code stored at an op code field of the instruction that identifies the associated load access as a final access to the target data and thus triggers the instruction pipeline 111 to initiate the process for discarding the data from the memory hierarchy 145. In other embodiments the special-purpose load instruction can include a control field that, when processed by the instruction pipeline 111, generates control information to indicate to the cache controller 115 that the load instruction indicates the final access to data at a cache line.

In some embodiments, the cache controller 115 can determine the final access to a group of data stored at a corresponding plurality of the cache lines of the cache 104 and, in response, discard the plurality of data. To illustrate, an executing program typically employs a stack structure to store spill data for a compiled program. The stack is an abstract structure that is embodied by multiple locations of the memory hierarchy 145. Accordingly, at least a portion of the stack includes data stored at the cache 104. The processor core 110 includes a stack pointer register that stores a stack pointer indicating the memory address for the top-most valid location of the stack. The stack pointer is adjusted in response to data being pushed onto or popped off of the stack. During execution of a compiled program methods are called, resulting in data associated with the method being placed on the stack and a corresponding adjustment of the stack pointer. Data that is only associated with a particular method is said to be in the “stack frame” of that method.

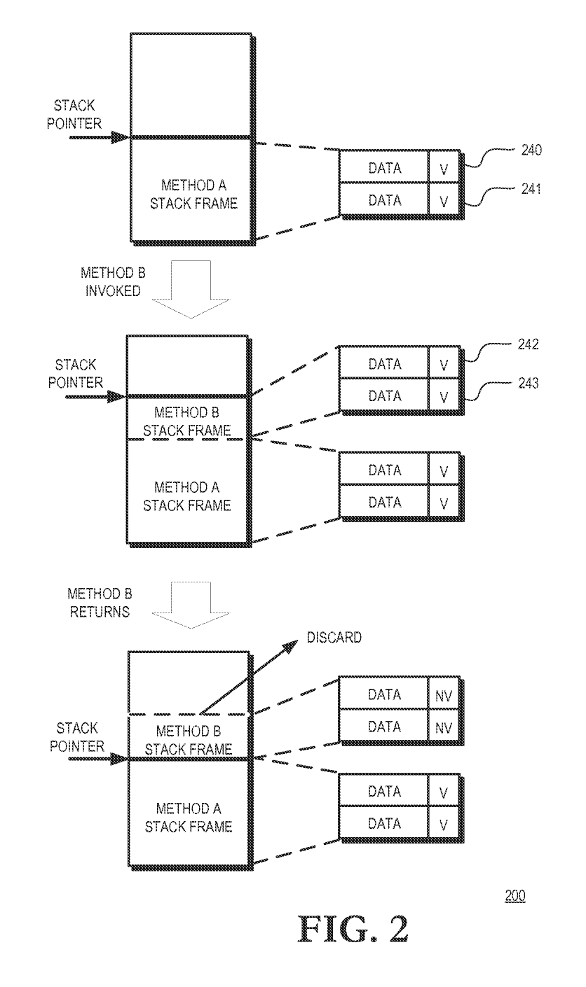

FIG. 2 illustrates the configuration of a stack 200 in accordance with some embodiments. Initially, the stack 200 stores a stack frame for a method designated Method A. Accordingly, the stack pointer is at the top of the Method A stack frame. FIG. 2 illustrates two cache lines 240 and 241 that store the data for the Method A stack frame. In the illustrated example, the cache lines 240 and 241 each include corresponding validity fields, which are set to indicate the cache lines are in the valid state. The data for the Method A stack frame is therefore maintained in the memory hierarchy.

In response to Method A calling another method, designated Method B, the instruction pipeline 111 adjusts the stack pointer to allocate a stack frame for Method B. Therefore, during execution of Method B, the instruction pipeline 111 accesses data associated with memory addresses located within the stack frame for Method B. This results in data associated with those memory addresses being stored at the cache 104 at cache lines 242 and 243. Because the data is being accessed over time, the cache lines 242 and 243 are indicated as valid cache lines. The data at these cache lines (the data for the Method B stack frame) is therefore part of the memory hierarchy 145, and is therefore maintained by the processor 102 in the memory hierarchy. Further, Method B requires loading of that data from the cache 104 to the register file 112, resulting in the cache lines 242 and 243 being placed in a dirty state. Eventually, Method B completes execution as indicated by a method return instruction. In response, the instruction pipeline sets the stack pointer so that it is at the top of the stack frame for Method A. Accordingly, the stack no longer includes the stack frame for Method B. The cache controller 115 tracks the stack pointer value and, in response to determining that the stack pointer has returned to the top of the stack frame for Method A, discards the data for the stack frame of Method B from the cache 104 by setting the cache lines 242 and 243 to invalid states. The cache lines 242 and 243 will therefore be replaced by new data without being transferred through the memory hierarchy 145, saving power and other system resources.

In some embodiments, the stack 200 can include a red zone portion that is not delineated by the stack pointer. The red zone is a defined set of memory addresses that store data for the stack, but the stack pointer is never moved into the red zone. The red zone thus forms a permanent part of the stack, but can be accessed without the overhead of modifying the stack pointer. Because the stack pointer is not moved when data in the red zone is accessed, movement of the stack pointer will not indicate the final access to data in the red zone. Accordingly, the cache controller 115 can maintain a list of cache lines associated with memory addresses in the red zone. In response to a method return or other indicator the cache controller 115 discards the data at the cache lines in the list. The cache controller 115 thereby prevents data stored at the red zone from being transferred through the memory hierarchy 145.

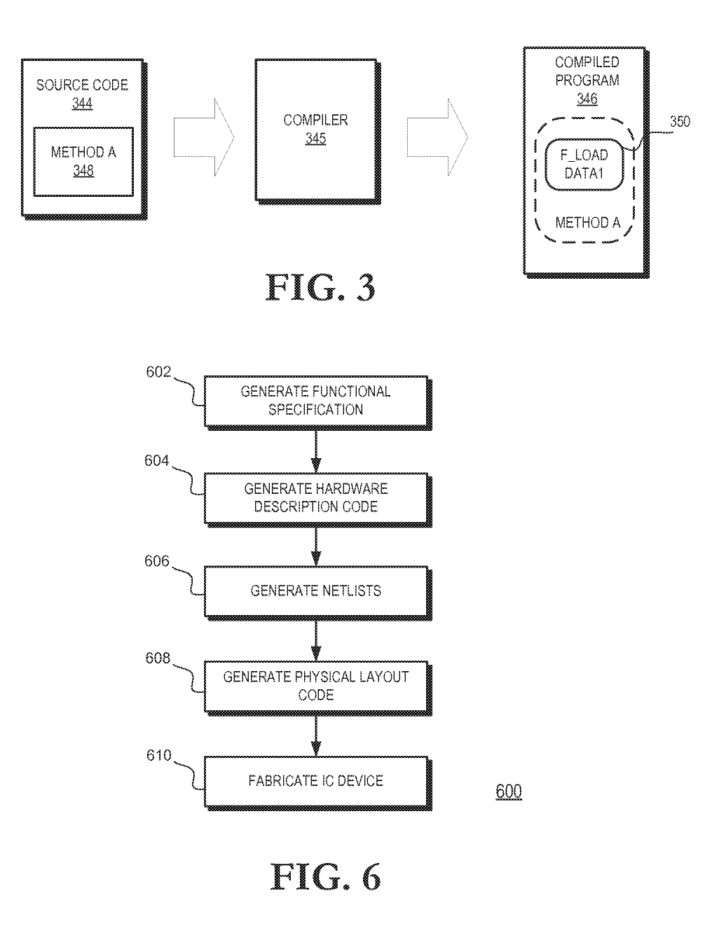

FIG. 3 illustrates the process of compiling source code 344 into a compiled computer program 346 in accordance with some embodiments. The compiled computer program 346 is generated by a compiler 345 to include a special-purpose load instruction 350 (designated “F_LOAD”) that indicates to the cache controller 115 (FIG. 1) that it can discard data designated DATA1. In particular, the source code 344 includes a method 348 that uses DATA1. During compilation of the source code 344 the compiler 345 determines the final instruction of the method 348 that manipulates DATA1. Conventionally, the compiler 345 would generate a normal load instruction for the final instruction to load DATA1 from the cache 104 into one of the registers at register file 112 (FIG. 1) for manipulation. However, because it has determined the instruction is the final instruction to manipulate DATA1, the compiler 345 automatically generates the special-purpose load instruction 350. In response to receiving the special-purpose load instruction the cache controller 115 provides DATA1 from its cache line as it would for a normal load instruction. In addition, the cache controller 115 discards DATA1 from the memory hierarchy 145.

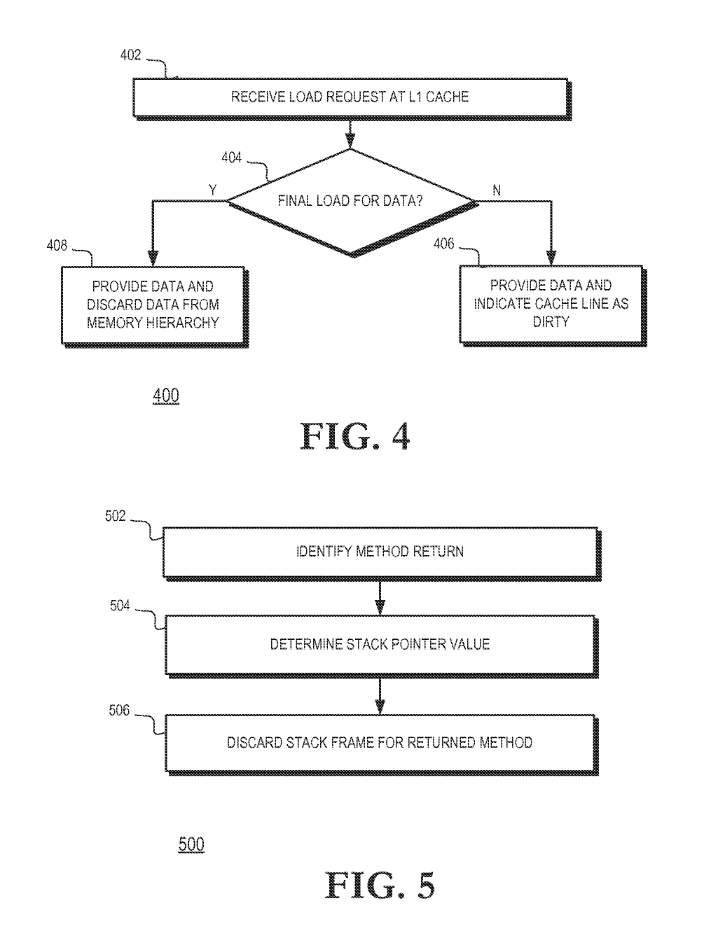

FIG. 4 illustrates a flow diagram of a method of discarding spill data from a cache in accordance with some embodiments. For ease of illustration, FIG. 4 is described with respect to an example implementation at the processing system 100 of FIG. 1. At block 402 the cache controller 115 receives a load request to load data at a cache line of the storage array 116. In response, at block 404 the cache controller 115 determines if the load request is the final load request for the data. In some embodiments this determination is made based on an op code or other control information of the instruction that triggered the load request. If the load request is not the final load request for the data, the method flow moves to block 406 and the cache controller 115 provides the data to the processor core 110. In addition, the cache controller 115 marks the clear field for the cache line to indicate the data is dirty. If, at block 404, the cache controller 115 determines that the load request is the final load request for the data, the method flow moves to block 408 and the cache controller 115 provides the requested data from the cache line. In addition, the cache controller 115 discards the data from the memory hierarchy 145, either by marking the cache line as invalid or by setting the clean field of the cache line to indicate clean data and setting the LRU field of the cache line to indicate the data is the least recently used data at the storage array 116.

FIG. 5 illustrates a flow diagram of a method 500 of discarding spill data from a stack in accordance with some embodiments of the present disclosure. For purposes of illustration, the method 500 will be described with respect to an example implementation at the processing system 100 of FIG. 1. At block 502 the cache controller 115 receives an indication that a method executing at the instruction pipeline 111 has returned. The indication can be based on an explicit method return instruction, based on a change in the stack pointer at the stack pointer register 113, and the like. In response to the indication, at block 504 the cache controller 115 reads the stack pointer value to determine the top most location of the stack. At block 506 the cache controller 115 discards the data stored at the storage array 116 that was in the stack frame of the returned method. For example, the cache controller 115 can keep determine the cache lines that store data associated with memory addresses above (greater than) the memory address indicated by the stack pointer value and can discard those cache lines.

In some embodiments, the apparatus and techniques described above are implemented in a system comprising one or more integrated circuit (IC) devices (also referred to as integrated circuit packages or microchips), such as the processor described above with reference to FIGS. 1-5. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

FIG. 6 is a flow diagram illustrating an example method 600 for the design and fabrication of an IC device implementing one or more aspects in accordance with some embodiments. As noted above, the code generated for each of the following processes is stored or otherwise embodied in computer readable storage media for access and use by the corresponding design tool or fabrication tool.

At block 602 a functional specification for the IC device is generated. The functional specification (often referred to as a micro architecture specification (MAS)) may be represented by any of a variety of programming languages or modeling languages, including C, C++, SystemC, Simulink, or MATLAB.

At block 604, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 606 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 608, one or more EDA tools use the netlists produced at block 606 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 610, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored on a computer readable medium that, when executed by the one or more processors, manipulate the one or more processors to perform one or more aspects of the techniques described above. The software is stored or otherwise tangibly embodied on a computer readable storage medium accessible to the processing system, and can include the instructions and certain data utilized during the execution of the instructions to perform the corresponding aspects.

As disclosed herein, in some embodiments a method includes, in response to a field of an instruction indicating a final access to first data stored at a memory hierarchy of a processor, discarding the first data from the memory hierarchy. In some aspects, the instruction comprises a load instruction that results in a load access to the first data and the field stores a value identifying the load access as the final access. In some aspects the field of the load instruction comprises an op code field. In some aspects, the method includes automatically generating the load instruction at a compiler in response to determining a source code instruction indicates the final access to the first data. In some aspects the method includes determining the final access to the first data further based upon a modification of a stack pointer that results in the first data being removed from the stack. In some aspects, the method includes discarding a plurality of data including the first data and a second data in response to the final access to the first data. In some aspects the method includes determining the final access to the first data based on a stack pointer indicating a stack does not include the first data and the second data. In some aspects the method includes discarding the first data comprises marking the data as unmodified and as least recently used data in a cache of the memory hierarchy. In some aspects discarding the first data comprises marking the data as invalid in a cache of the memory hierarchy.

In some embodiments a method includes, in response to a change in a stack pointer of a stack of a processor that results in of a first plurality of data being removed from the stack, discarding the first plurality of data from a memory hierarchy of the processor. In some aspects the change in the stack pointer of the processor indicates the first plurality of data is not to be accessed by a program executing at the processor. In some aspects the method includes initiating the change in the stack pointer in response to a method return instruction. In some aspects the method includes discarding a second plurality of data from a red zone of the stack in response to the change in the stack pointer, the red zone comprising a defined set of memory addresses that form a part of the stack not accessed with the stack pointer.

In some embodiments, a processor includes a cache to store first data; and a cache controller to discard, based on the field of an instruction, the first data from the cache in response to a final access to the first data by a program executing at the processor. In some aspects the processor includes an instruction pipeline to execute the instruction, the instruction comprising a load instruction including a field storing a value that identifies a load access represented by the load instruction as the final access to the first data; and the cache controller is to determine the final access to the first data responsive to the load instruction including the field. In some aspects the processor includes an instruction pipeline to execute the instruction, the instruction comprising a method return instruction. In some aspects the processor includes a register to store a stack pointer indicating a location of a stack; and the cache controller is to determine the final access to the first data based on the stack pointer indicating the stack does not include the first data. In some aspects the cache controller is to discard a plurality of data including the first data and a second data in response to the final access to the first data. In some aspects, the processor includes a register to store a stack pointer indicating a location of a stack; and the cache controller is to determine the final access to the first data based upon the stack pointer indicating the stack does not include the first data and the second data. In some aspects the cache controller is to discard the first data by marking the data as unmodified and as least recently used data in the cache. In some aspects the cache controller is to discard the first data by marking the data as invalid in the cache.

In some embodiments a computer readable medium stores code to adapt at least one computer system to perform a portion of a process to fabricate at least part of a processor, the processor including: a cache to store first data; and a cache controller to discard, based on the field of an instruction, the first data from the cache in response to a final access to the first data by a program executing at the processor. In some aspects the processor further includes an instruction pipeline to execute the instruction, the instruction comprising a load instruction including a field storing a value that identifies a load access represented by the load instruction as the final access to the first data; and wherein the cache controller is to determine the final access to the first data responsive to the load instruction including the field. In some aspects the processor includes an instruction pipeline to execute the instruction, the instruction comprising a method return instruction. In some aspects the processor includes a register to store a stack pointer indicating a location of a stack; and the cache controller is to determine the final access to the first data based upon the stack pointer indicating the stack does not include the first data.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method, comprising:
in response to a field of an instruction indicating a final access to first data stored at a memory hierarchy of a processor, discarding the first data from the memory hierarchy.

2. The method of claim 1, wherein the instruction comprises a load instruction that results in a load access to the first data and the field stores a value identifying the load access as the final access.

3. The method of claim 2 wherein the field of the load instruction comprises an op code field.

4. The method of claim 2, further comprising automatically generating the load instruction at a compiler in response to determining a source code instruction indicates the final access to the first data.

5. The method of claim 1, further comprising:
determining the final access to the first data further based upon a modification of a stack pointer that results in the first data being removed from the stack.

6. The method of claim 1, further comprising:
discarding a plurality of data including the first data and a second data in response to the final access to the first data.

7. The method of claim 6, further comprising:
determining the final access to the first data based on a stack pointer indicating a stack does not include the first data and the second data.

8. The method of claim 1, wherein discarding the first data comprises marking the data as unmodified and as least recently used data in a cache of the memory hierarchy.

9. The method of claim 1, wherein discarding the first data comprises marking the data as invalid in a cache of the memory hierarchy.

10. A method, comprising:
in response to a change in a stack pointer of a stack of a processor that results in of a first plurality of data being removed from the stack, discarding the first plurality of data from a memory hierarchy of the processor.

11. The method of claim 10, wherein the change in the stack pointer of the processor indicates the first plurality of data is not to be accessed by a program executing at the processor.

12. The method of claim 10, further comprising:
initiating the change in the stack pointer in response to a method return instruction.

13. The method of claim 10 further comprising:
discarding a second plurality of data from a red zone of the stack in response to the change in the stack pointer, the red zone comprising a defined set of memory addresses that form a part of the stack not accessed with the stack pointer.

14. A processor, comprising:
a cache to store first data; and
a cache controller to discard, based on the field of an instruction, the first data from the cache in response to a final access to the first data by a program executing at the processor.

15. The processor of claim 14, further comprising:
an instruction pipeline to execute the instruction, the instruction comprising a load instruction including a field storing a value that identifies a load access represented by the load instruction as the final access to the first data; and
wherein the cache controller is to determine the final access to the first data responsive to the load instruction including the field.

16. The processor of claim 14, further comprising:
an instruction pipeline to execute the instruction, the instruction comprising a method return instruction.

17. The processor of claim 14, further comprising:
a register to store a stack pointer indicating a location of a stack; and
wherein the cache controller is to determine the final access to the first data based on the stack pointer indicating the stack does not include the first data.

18. The processor of claim 14, wherein the cache controller is to discard a plurality of data including the first data and a second data in response to the final access to the first data.

19. The processor of claim 18, further comprising:
a register to store a stack pointer indicating a location of a stack; and
wherein the cache controller is to determine the final access to the first data based upon the stack pointer indicating the stack does not include the first data and the second data.

20. The processor of claim 14, wherein the cache controller is to discard the first data by marking the data as unmodified and as least recently used data in the cache.

21. The processor of claim 14, wherein the cache controller is to discard the first data by marking the data as invalid in the cache.

22. A computer readable medium storing code to adapt at least one computer system to perform a portion of a process to fabricate at least part of a processor, the processor comprising:
a cache to store first data; and
a cache controller to discard, based on the field of an instruction, the first data from the cache in response to a final access to the first data by a program executing at the processor.

23. The computer readable medium of claim 22, the processor further comprising:
an instruction pipeline to execute the instruction, the instruction comprising a load instruction including a field storing a value that identifies a load access represented by the load instruction as the final access to the first data; and
wherein the cache controller is to determine the final access to the first data responsive to the load instruction including the field.

24. The computer readable medium of claim 22, the processor further comprising:
an instruction pipeline to execute the instruction, the instruction comprising a method return instruction.

25. The computer readable medium of claim 22, the processor further comprising:
a register to store a stack pointer indicating a location of a stack; and
wherein the cache controller is to determine the final access to the first data based upon the stack pointer indicating the stack does not include the first data.
